(19) United States
(12) Patent Application Publication
(10) Pub. No.: US 2007/0120676 A1
(43) Pub. Date: May 31, 2007

(54) RFID SYSTEM INCLUDING THRESHOLD ADJUSTER

(75) Inventors: Jun Seok PARK, Seoul (KR); Ha Ryeng Oh, Goyang (KR); Yeong Rak Seong, Goyang (KR)

Correspondence Address: SUGHRUE MION, PLLC, 2100 PENNSYLVANIA AVENUE, N.W., SUITE 800, WASHINGTON, DC, 20037, US

(73) Assignee: U-Comm Technology

(21) Appl. No.: 11/562,912

(22) Filed: Nov. 22, 2006

(30) Foreign Application Priority Data
Nov. 30, 2005 (KR) KR10-2005-0115925

(51) Int. Cl. G08B 13/14; H04Q 5/22

(52) U.S. Cl. 340/572.4; 340/10.1

(57) ABSTRACT

The present invention discloses an RFID (Radio Frequency Identification) system for reading and writing an identification information of an RFID tag in a non-contacting manner using a radio frequency. In accordance with RFID system of the present invention, a threshold value of a comparator is adjusted in order to accurately detect a response signal dynamically generated according to an environmental condition including a distance between a reader and the tag.

### BACKGROUND OF THE INVENTION

1. Field of the Invention

The present invention relates to an RFID (Radio Frequency Identification) system for reading and writing an identification information of an RFID tag in a non-contacting manner using a radio frequency, and in particular to an RFID system including a threshold adjuster wherein a threshold may be accurately adjusted in order to accurately detect a response signal dynamically generated according to an environmental condition including a distance between a reader and the tag.

2. Description of Prior Art

An RFID refers to a technology wherein a unique identification information is inputted in a small IC chip and an object or an animal having the IC chip attached thereto is recognized, traced or managed using the radio frequency. The RFID system comprises an RFID tag or an RFID transponder having the unique identification information stored therein and being attached to the object or the animal, and a reader or an interrogator reading or writing the identification information stored in the tag. An information processing apparatus such as a computer is connected to the reader to process a data collected from the tag.

FIG. 1 is a configuration diagram illustrating a basic structure of a conventional RFID system.

As shown, a tag 5 is a passive tag that does not have an internal power supply, and comprises a small semiconductor IC chip and an antenna. The IC chip includes an RF circuit, a logic circuit and a memory. The tag 5 has various sizes and shapes. A reader 1 comprises a transmitter for transmitting an RF signal of a predetermined frequency band to the tag 5, and a receiver for receiving a signal transmitted from the tag 5, and an antenna for transceiving the signals.

FIG. 2 is a configuration diagram illustrating a basic operation of the conventional RFID system of FIG. 1.

As shown, the reader 1 transmits the RF signal of the predetermined frequency band including a high frequency carrier signal and a certain inquiry signal. When the tag 5 is placed in a magnetic field of the reader 1 formed by the RF signal, the tag 5 is supplied with an operating power supply required for operating the IC chip from the high frequency carrier signal. That is, the high frequency carrier signal transmitted from the reader 1 generates an AC in the antenna of the tag, and the generated AC is rectified to be used as an electrical energy for the IC chip. In addition, the tag 5 modulates the received RF signal, and the data stored in the tag 5 is subjected to a backscattered modulation based on the modulated RF signal to be transmitted to the reader 1 as a response signal. As described above, in accordance with the conventional RFID system, a power transmission for activating the passive tag is carried out as well as a data transmission between the reader 1 and the tag 5.

Generally, since the passive tag that does not have the internal power supply has a short recognition distance of less than one meter, a short range RFID system of a low frequency (125 kHz, 12.56 MHz) is mainly used. The short range RFID system transmits the power and the signal by a winding coil of the reader, and the tag generates a power supply energy and receives the signal via a magnetic coupling by the magnetic field of AC flowing in the coil. Therefore, the conventional low frequency RFID system using the passive tag having the short recognition distance is used for a limited purpose such as entrance management and a traffic card.

On the other hand, an active tag having a long recognition distance that allows reading/writing and includes a sensor to allow a history management and an environmental information sensing has a large power consumption so that the active tag should include a battery. Therefore, the active tag is disadvantageous in that the active tag may hardly be miniaturized, has a high price and a limited usable span according to a span of the battery.

Recently, a standardization of the passive RFID technology using the magnetic field and the backscattered modulation in a UHF band of 860-960 KHz and 2.4 Ghz is in progress. Accordingly, the recognition distance of the passive tag is expected to be increased to five meters. In addition, a communication distance between the tag and the reader may be increased when a transmission output of the reader is increased and the antenna of the tag is enlarged.

Moreover, the RFID tag is expected to progress from the passive type that merely transmits the identification information according to a request of the reader to a ubiquitous sensor having a sensing function to actively sense the environmental information such as a temperature, humidity, a pollution information and a crack information to be transmitted to a network. In addition, in accordance with a USN (Ubiquitous Sensor Network), a subminiature tag is attached to the animal or a human as well as the objects such as a telephone pole, a sidewalk, a wall or a floor of a building to collect the information in real time using wireless readers installed in various places or a mobile wireless reader carried by a user and to transmit the collected information to the network.

Therefore, in order to build the USN, a development of a low price, high performance and subminiature tag should be preceded. The tag suitable for the USN (uSensor) should have the low price as well as a small size so as to be installed anywhere, and have the sensing function, the high performance to process a large amount of information and a sufficient long recognition distance.

FIG. 3 is a diagram illustrating a detailed configuration of the reader 10 shown in FIG. 1.

As shown, the reader 1 in accordance with the present invention, comprises a first frequency synthesizer 13 for mixing I and Q signals generated by modulating a data of a digital processor 14, a forward signal processor 10 including a transmitter 15 for transmitting an output signal of the first frequency synthesizer 13 to a tag 50 through a coupler 16 an RF antenna 17 after amplifying the same to a predetermined level.

In addition, the reader 1 comprises a receiver 31 for adjusting a gain after amplifying a response signal of the tag 50 received through the RF antenna 17 and the coupler 16, and a reverse signal processor 30 including a second frequency synthesizer 33 for providing a demodulated signal (I signal and Q signal) to the digital processor 14 by generating a predetermined frequency in order to receive a response signal of the tag 50 through a frequency channel identical to a frequency provided to the tag 50 through the transmitter 15 and mixing the output signal of the receiver 31.

An RF signal f1 including the inquiry signal is transmitted to the tag 50 through the RF antenna 17.

The RF signal received through the receiver 31 is demodulated through the frequency channel coherent with the frequency channel transmitted through the transmitter 15 by the second frequency synthesizer 33 to output the I and Q signals.

In accordance with the conventional RFID system, a magnitude of the RF signal provided from the tag varies dynamically according to a communication environment including the distance between the reader and the tag. It is difficult to interpret the received RF signal of the tag due to a peak value varying dynamically and a noise of an actual RF signal. Therefore, an apparatus for separately setting a threshold corresponding to the response signal is required in order to accurately detect the receive response signal of the tag.

### SUMMARY OF THE INVENTION

It is an object of the present invention to provide an RFID system wherein a response characteristic is improved by adjusting a threshold value through a parameter sweep in order to accurately detect a response signal dynamically generated according to an external environment condition including a distance between the reader and the tag.

In order to achieve the above-described objects of the present invention, there is provided an RFID system for reading an information stored in a tag according to a signal transmitted by a reader, the system comprising: an threshold adjuster including one or more threshold values, the threshold adjuster comparing an information signal demodulated from a response signal received from the tag to each of the one or more threshold values to output an output signal according to the comparison; and a digital processor for receiving the output signal being outputted from the threshold adjuster to determine a validity of the response signal according to the output signal.

It is preferable that the threshold adjuster comprises: a controller for outputting the one or more threshold values; and a comparator for comparing the information signal to each of the one or more threshold values.

It is also preferable that the threshold adjuster comprises: a reference voltage generator for generating one or more reference voltages corresponding to the one or more threshold values; and one or more comparator for comparing each of the one or more reference voltages to the information signal.

Preferably, the reference voltage generator comprises a voltage source for supplying a constant voltage and a voltage divider for dividing the constant voltage by a predetermined ratio.

### BRIEF DESCRIPTION OF THE DRAWINGS

FIG. 1 is a configuration diagram illustrating a basic structure of a conventional RFID system.

FIG. 2 is a configuration diagram illustrating a basic operation of the conventional RFID system of FIG. 1.

FIG. 3 is a diagram illustrating a detailed configuration of a reader shown in FIG. 1.

FIG. 4 is a diagram illustrating a configuration of a RFID system in accordance with the present invention.

FIG. 5 is a diagram illustrating an example of a configuration of a threshold adjuster shown in FIG. 4.

FIG. 6 is a diagram illustrating another example of a configuration of the threshold adjuster shown in FIG. 4.

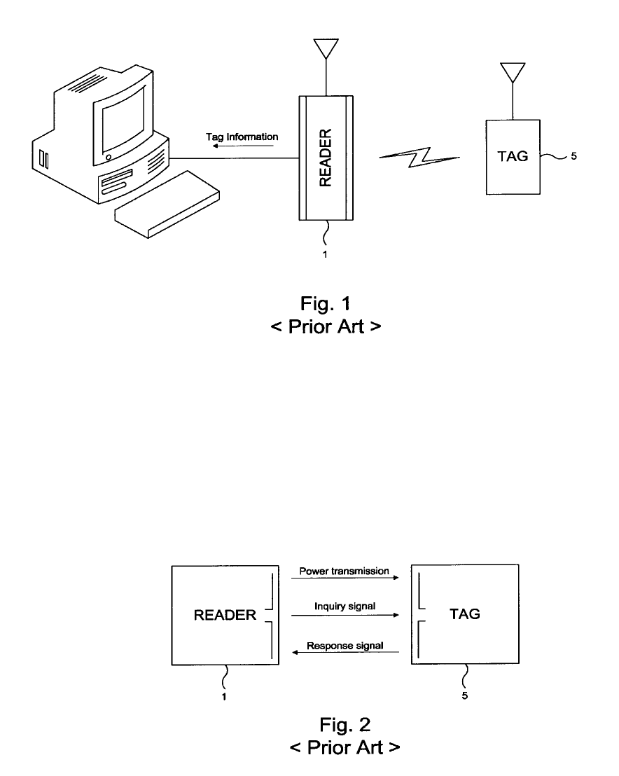

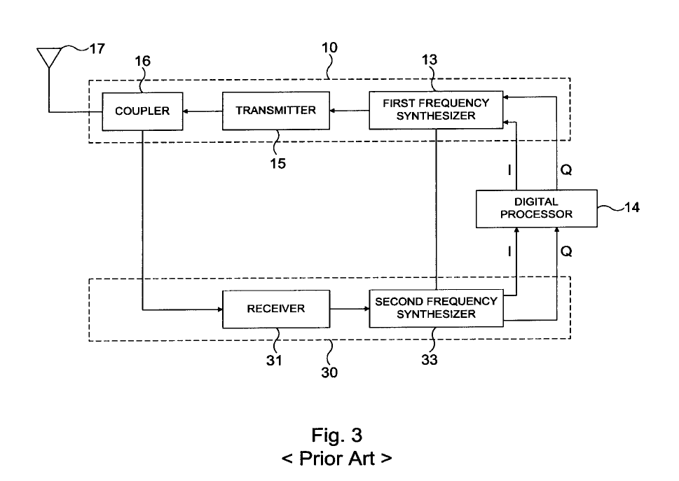

### DETAILED DESCRIPTION OF THE PREFERRED EMBODIMENTS

The present invention will now be described in detail with reference to the accompanied drawings.

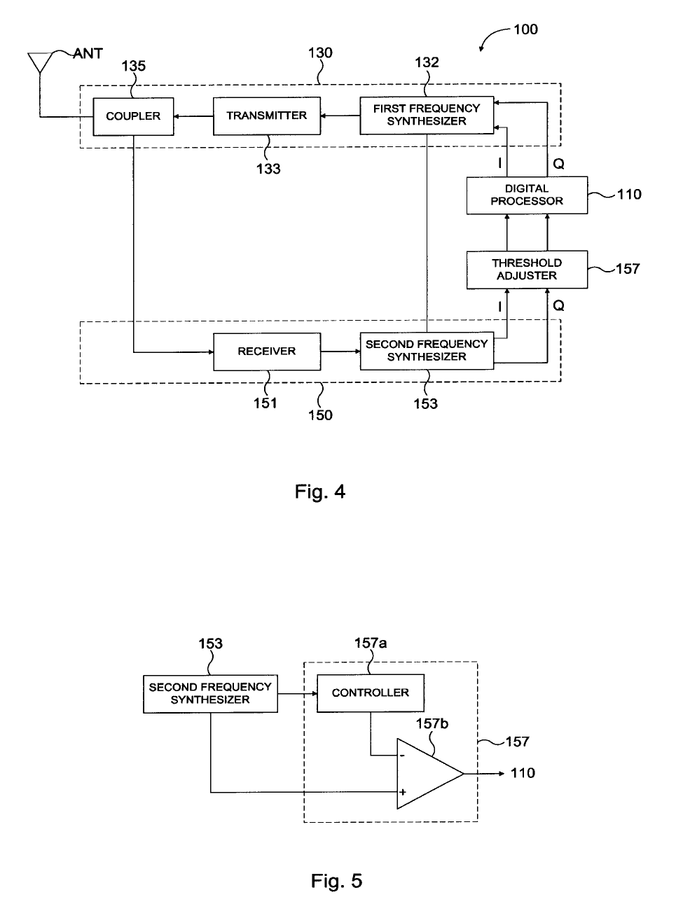

FIG. 4 is a diagram illustrating a configuration of a RFID system in accordance with the present invention.

Referring to FIG. 4, the RFID system in accordance with the present invention comprises a reader 100 for tranceiving an RF signal, and a tag (not shown) transmitting an information stored therein to the reader 100 using the RF signal in a predetermined frequency band transmitted by the reader 100 via a backscattered modulation. The reader 100 comprises a digital processor 110 for processing a received or a transmitted signal, a threshold adjuster 157 for comparing and outputting a threshold value and an information signal, a forward signal processor 130 for providing a modulated signal outputted by the digital processor 110 to the tag through an RF antenna ANT, and a reverse signal processor 150 for receiving the RF signal provided by the tag and transmitting the same to the digital processor 110.

The forward signal processor 130 comprises a first frequency synthesizer 132 for mixing I and Q signals generated from a data in the digital processor 110 with a carrier signal of a communication channel, a transmitter 133 for amplifying an output signal of the first frequency synthesizer 132 to a predetermined level so as to be transmitted to the tag through the RF antenna ANT, and a coupler 135 for selecting a reception or a transmission of the signal.

The reverse signal processor 150 comprises a receiver 151 for receiving and amplifying a response signal from the tag through the RF antenna ANT to a predetermined level, and a second frequency synthesizer 153 demodulating the information signal including an information stored in the tag from the response signal received through a frequency channel identical to an output frequency channel of the first frequency synthesizer 13 to be output as a demodulated signal (I and Q signals).

The threshold adjuster 157 includes one or more threshold values and compares the information signal demodulated from the response signal to the one or more threshold values to be output.

The digital processor 110 receives the output signal being outputted from the threshold adjuster 157 to determine a validity of the response signal received from the tag. The digital processor 110 may comprise a universal digital signal processor (DSP), a microprocessor, a dedicated digital signal processor or combinations thereof.

FIG. 5 is a diagram illustrating an example of the configuration of the threshold adjuster 157 shown in FIG. 4.

Referring to FIG. 5, the threshold adjuster 157 comprises a controller 157a including a program for executing a parameter sweep, a comparator 157b for comparing the threshold value set by the controller 157a and the information signal.

The controller 157a includes the one or more threshold values and outputs the one or more threshold values. The one or more threshold values are values obtained by dividing a voltage into steps. For instance, a voltage of 1V is divided into 100 mV, 150 mV, 200 mV, 250 mV, 300 mV and 350 mV, 100 mV, 150 mV, 200 mV, 250 mV, 300 mV and 350 mV are set as the one or more threshold values.

The controller 157a sequentially outputs the one or more threshold values to the comparator 157b. The parameter sweep refers to outputting a predetermined voltage in steps. The controller 157a may comprise at least on of the program for executing the parameter sweep, an analog to digital converter, a plurality of reference voltage generators and switch blocks.

The comparator 157b compares the one or more threshold values to the information signal to output a logic value of “H” or “L”. That is, each of the one or more threshold values is sequentially compared to the information signal and, the logic value of “H” is output when the information signal is larger than the threshold value and the logic value of “L” is output when the information signal is smaller than the threshold value.

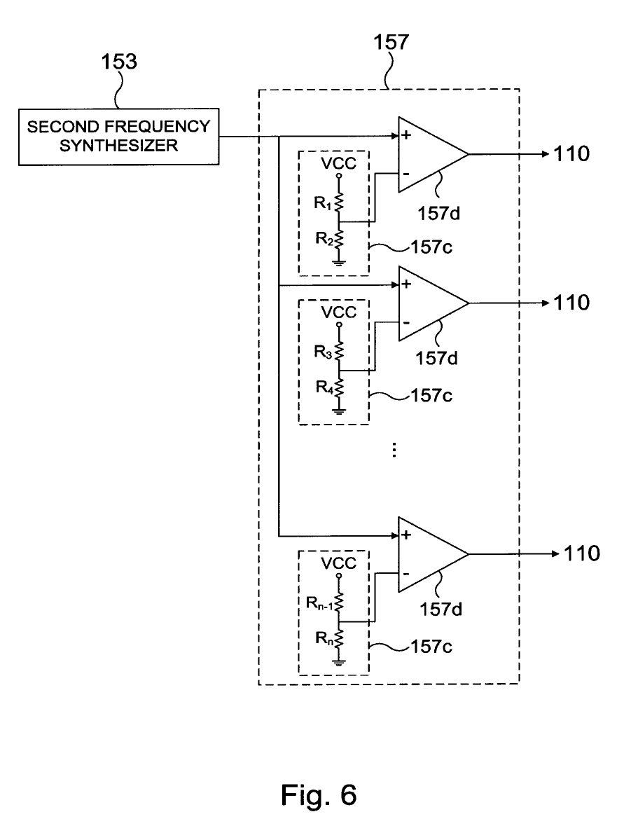

FIG. 6 is a diagram illustrating another example of a configuration of the threshold adjuster 157c shown in FIG. 4.

Referring to FIG. 6, the threshold adjuster 157 comprises one or more reference voltage generator 157c for generating one or more reference voltages corresponding to the one or more threshold values, and one ore more comparators 157d for comparing the one or more reference voltages outputted from the reference voltage generator 157c to the information signal.

Each of the reference voltage generators 157c may comprise a voltage source VCC for supplying a constant voltage and one or more voltage dividers R₁-Rₙ for dividing the voltage by a predetermined ratio.

It is preferable that the number of the reference voltage generators 157c and that of the comparators 157d is the same.

One or more reference voltages such as a first reference voltage generated by the voltage divider consisting of the resistors R₁ and R₂ and a second reference voltage generated by the voltage divider consisting of the resistors R₃ and R₄ is supplied to the one ore more comparators 157d, and each of the one ore more comparators 157d that has received the demodulated information signal from the tag compares the reference voltage to the information signal to output a result thereof. The output signal is provided to the digital processor 110.

The digital processor 110 determines whether the output signal of the comparator has a correct frame and a correct CRC value. That is, the frame is determined to be incorrect or invalid when a duration of the frame is out of a certain range. In addition, the CRC value is determined to be incorrect when an error exist in the CRC value. When the frame has the invalid frame or CRC value, the output signal is determined to be invalid.

When the output signal is valid, the corresponding threshold value is a proper threshold value. When the output signal is invalid, other threshold value is compared to the information signal.

The digital processor 110 may provide the collected information to a computer (not shown) or a host server (not shown) via a network (not shown).

An operation process of the RFID system in accordance with the present invention is described below in detail.

The first frequency synthesizer 132 generates the carrier signal having a frequency in use in order to transmit the inquiry signal. The generated carrier signal and the inquiry signal are mixed (modulated) to be transmitted to the transmitter 133. The transmitter 133 amplifies the mixed signal and transmits the amplified signal to the tag via the coupler 135 and the RF antennal ANT.

The tag that has received the inquiry signal generates the response signal to be transmitted to the reader 100.

The response signal of the tag is transmitted to the receiver 151 of the reverse signal processor 150 through the RF antenna ANT and the coupler 135. The receiver 151 amplifies the response signal to a predetermined level through a bandpass filter (not shown), a low noise amplifier (not shown) and a automatic gain controller (not shown). The amplified response signal is outputted through the frequency channel identical to the output frequency channel of the second frequency synthesizer 153 by the second frequency synthesizer 153. That is, the response signal is demodulated to the information signal (I and Q signals) including the information stored in the tag by the second frequency synthesizer 153.

The response signal demodulated by the second frequency synthesizer 153 is inputted to the threshold adjuster 157, and the threshold adjuster 157 compares the one or more threshold values to the response signal sequentially.

That is, the controller 157a of the threshold adjuster 157 varies the one or more threshold values through the parameter sweep and inputs each of the one or more threshold values to a non-inverting input terminal of the comparator 157b as a reference level. The information signal which is the output signal of the second frequency synthesizer 153 is inputted to an inverting input terminal of the comparator 157b such that the threshold value and the information signal are compared.

The output signal of the comparator 157b is inputted to the digital processor 110.

The comparator outputs different comparison results by varying the threshold value which is the reference level because the response signal varies according to a distance between the reader and the tag.

Accordingly, the digital processor 110 determines the validity of the signal by checking the frame and the CRC value. When the signal is valid, the corresponding threshold value is the proper threshold value. When the signal is invalid, the signal is ignored. The digital processor 110 may provide the collected information to the computer or the host server through the network.

As described above, the RFID system in accordance with the present invention is advantageous in that a response characteristic is improved by adjusting the threshold value through the parameter sweep in order to accurately detect the response signal dynamically generated according to an external environment condition including the distance between the reader and the tag.

While the present invention has been particularly shown and described with reference to the preferred embodiment thereof, it will be understood by those skilled in the art that various changes in form and details may be effected therein without departing from the spirit and scope of the invention.

1. An RFID system for reading an information stored in a tag according to a signal transmitted by a reader, the system comprising:
an threshold adjuster including one or more threshold values, the threshold adjuster comparing an information signal demodulated from a response signal received from the tag to each of the one or more threshold values to output an output signal according to the comparison; and
a digital processor for receiving the output signal being outputted from the threshold adjuster to determine a validity of the response signal according to the output signal.

2. The system in accordance with claim 1, wherein the threshold adjuster comprises:
a controller for outputting the one or more threshold values; and
a comparator for comparing the information signal to each of the one or more threshold values.

3. The system in accordance with claim 1, wherein the threshold adjuster comprises:
a reference voltage generator for generating one or more reference voltages corresponding to the one or more threshold values; and
one or more comparator for comparing each of the one or more reference voltages to the information signal.

4. The system in accordance with claim 3, wherein the reference voltage generator comprises a voltage source for supplying a constant voltage and a voltage divider for dividing the constant voltage by a predetermined ratio.
